(19) United States
(12) Patent Application Publication
(10) Pub. No.: US 2007/0268267 A1
(43) Pub. Date: Nov. 22, 2007

(54) Transmission apparatus and transmission method thereof

(76) Inventor: Ching-Tzun Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/515,848

(22) Filed: Sep. 6, 2006

(30) Foreign Application Priority Data
May 16, 2006 (TW) 095117396

(51) Int. Cl. G06F 3/041

(52) U.S. Cl. 345/173

(57) ABSTRACT

A transmission apparatus and a transmission method are disclosed. The transmission apparatus comprises a handwritten input unit, a processing unit and an execution unit. The handwritten input unit is provided with a handwritten screen for continuously inputting a plurality of handwritten scripts or at least one handwritten pattern. The processing unit then converts the handwritten scripts into a string of pluralized script patterns. The script patterns are shrunk and transformed into a string of pluralized micro-patterns sequentially. Alternatively, the foregoing handwritten patterns are converted into a command instruction. The execution unit then transmits the micro-patterns to an external receiving end sequentially. Alternatively, a corresponding program is then executed based on the command instruction.

### FIELD OF THE INVENTION

The present invention relates to a transmission apparatus and a transmission method, and more particularly to the technical area of transmitting handwritten scripts or converting handwritten patterns.

### BACKGROUND OF THE INVENTION

At present, various different handheld apparatuses are used extensively anytime and anywhere; for instance, a personal digital assistant (PDA) together with a global positioning system (GPS) device are used for tour navigation, mobile phone communication, memorandum and data record management, sending and receiving emails, transmitting short messages, or using instant message communication such as Microsoft's MSN or Yahoo's QQ instant message software. With the aforementioned communication technologies, users can enter short messages or click required functions through voice recognition, handwriting recognition, or touch a function key on a touch screen or a keyboard. For instance, when a user is traveling in a rapid transit or a motor vehicle or situated at an easily shaking or noisy environment, or when a user is busy and has no time for carrying out the handwritten recognition and watching a small screen to select the inputted characters, the user may use the voice recognition or handwritten recognition to input short messages or MSN instant messages. However, different recognition percentages or inconvenient inputs and transmissions may result from the user's unclear pronunciations, the scratchy handwritten scripts, the shaking or noisy environment, or improper timing of the use.

In view of the shortcomings of the prior art, there is a need for providing a convenient transmission apparatus and transmission method for the user.

### SUMMARY OF THE INVENTION

A primary object of the present invention is to provide a transmission apparatus and a transmission method, such that users can input short messages or control the execution of command instructions by a gesture while the users are traveling in a rapid transit or a motor vehicle or situated at an easily shaking or noisy environment.

A secondary object of the present invention is to provide a transmission apparatus and a transmission method, such that users can enter short messages or control the execution of command instruction by a gesture input while the users are busy and have no time to carry out the handwritten recognition and watch a small screen to select the inputted characters.

A third object of the present invention is to provide a transmission apparatus and a transmission method that exempt from processing voice recognition and handwriting recognition by a computer and that allow users to transmit short messages or control the execution of command instructions by using a simple gesture input without considering the variations of the voice recognition rate and the handwriting recognition rate.

A fourth object of the present invention is to provide a transmission apparatus and a transmission method, such that when users perform short message communication or MSN instant message communication, users can use the textual messages with their personality or personal styles for transmitting, and there is no need to switch or limit to languages.

A fifth object of the present invention is to provide a transmission apparatus and a transmission method, such that when users conduct short message communication or MSN instant message communication, users can directly transmit handwritten graphic files to avoid recognition mistakes or waste time on selecting or correcting the inputted characters.

A sixth object of the present invention based on the fifth object of the invention is to provide a transmission apparatus and a transmission method, when users perform short messages or MSN instant messages, users can transmit handwritten graphic files directly. Each graphic file includes a script pattern, and the script pattern is formed by a specific block so that users can modify the specific script pattern, just like editing a text file.

A seventh object of the present invention is to provide a transmission apparatus and a transmission method, such that users no longer need to watch the small characters on a screen and use a stylus to click the screen, but simply create different handwritten patterns by using a gesture input to control all functions of the transmission apparatus.

The foregoing transmission apparatus comprises a handwritten input unit, a processing unit and an execution unit. The handwritten input unit is provided with a handwritten screen, such that a user can input a handwritten script or a handwritten pattern onto the handwritten screen through a finger. Next, the processing unit converts the handwritten script into a script pattern and then shrinks the script pattern to a micro-pattern. Alternatively, the processing unit converts the handwritten pattern into a command instruction. The execution unit then transmits the micro-pattern to an external receiving end or executes a corresponding program according to the command instruction.

Further, the handwritten screen of the transmission apparatus further allows users to continuously input a plurality of handwritten scripts or a plurality of handwritten patterns. The processing unit converts the plurality of handwritten scripts into a string of pluralized script patterns sequentially and then shrinks the script patterns to a string of pluralized micro-patterns sequentially. Alternatively, the processing unit converts the handwritten patterns separately into a plurality of command instructions. The execution unit transmits the micro-patterns to an external receiving end sequentially or executes a corresponding program according to the command instruction. It is noteworthy to point out that the transmission apparatus could be a handheld apparatus, such as a personal digital assistant or a personal digital assistant with a global positioning system (GPS) device, and the handwritten screen could be a touch screen. Each script pattern and each micro-pattern are separately considered as a single graphic file.

In correspondence with the foregoing transmission apparatus, the present invention derives and generalizes a transmission method comprising the following steps:
(a) providing a handwritten screen to continuously input a plurality of handwritten scripts or at least one handwritten pattern;
(b) converting the handwritten scripts into a string of pluralized script patterns sequentially and then shrinking the script patterns to a string of pluralized micro-patterns sequentially, or converting the handwritten pattern into a command instruction; and
(c)transmitting the micro-patterns to an external receiving end sequentially, or executing a corresponding program based on the command instruction.

As the transmission apparatus described above, a plurality of handwritten scripts or a plurality of handwritten patterns can also be continuously inputted onto the handwritten screen by the user. Next, the handwritten scripts are converted into a string of pluralized script patterns sequentially and then the script patterns are shrunk to a string of pluralized micro-patterns sequentially to be transmitted to an external receiving end. Alternatively, the handwritten patterns are converted separately into a corresponding command instruction in order to execute a corresponding program. It is noteworthy to point out that the transmission method can be carried out by a handheld apparatus, such as a personal digital assistant or a personal digital assistant with a global positioning system (GPS) device, and the handwritten screen could be a touch screen. Each script pattern and each micro-pattern are separately considered as a single graphic file.

The invention can be more fully understood by reading following detailed description of the preferred embodiment with reference made to the accompanying drawings.

### BRIEF DESCRIPTION OF THE DRAWINGS

FIG. 1 is a schematic view of the operation of a transmission apparatus of the present invention;

FIG. 2 is another schematic view of the operation of a transmission apparatus of the present invention;

FIG. 3 is a further schematic view of the operation of a transmission apparatus of the present invention;

FIG. 4 is a flow chart of a transmission method according to a preferred embodiment of the present invention; and

FIG. 5 is a comparison table between the present invention and the prior art.

### DETAILED DESCRIPTION OF THE PREFERRED EMBODIMENTS

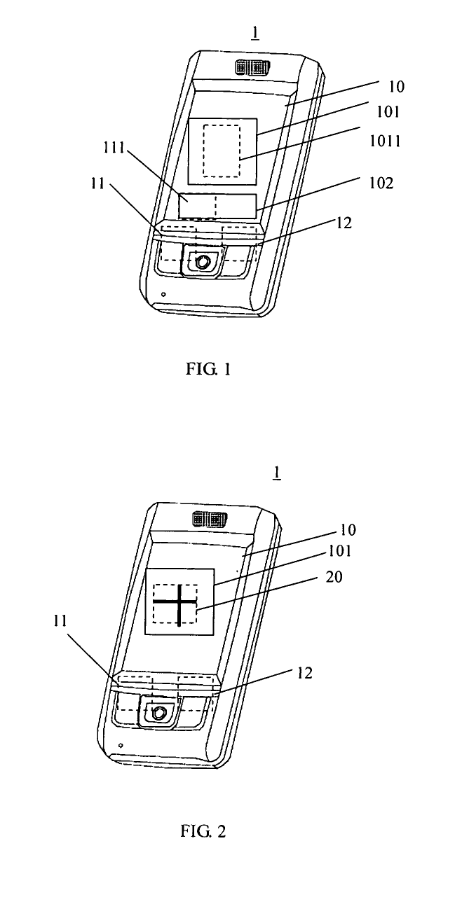

FIG. 1 is a schematic view of the operation of a transmission apparatus of the present invention. The transmission apparatus 1 comprises a handwritten input unit 10, a processing unit 11 and an execution unit 12. The handwritten input unit 10 is provided with a handwritten screen 101 for users to input a handwritten script 1011 onto the handwritten screen 101 by a finger. Next, the processing unit 11 converts the handwritten script 1011 into a graphic file or a script tracking file (not shown in the figure) of the script pattern and then shrinks the graphic file or the script tracking file of the script pattern to form a micro-pattern 111 shown at a bottom position 102 of the handwritten screen 101. Then, the micro-pattern 111 can be transmitted through the execution unit 12 or be deleted through the processing unit 11 at any moment based on user's demands.

FIG. 2 is another schematic view of the operation of a transmission apparatus of the present invention. The handwritten screen 101 of the transmission apparatus 1 is further provided for users to input a handwritten pattern 20 on the handwritten screen 101 by a finger, such as using a finger to draw a circle or a cross or different predetermined figures on the handwritten screen 101. Next, the processing unit 11 converts the handwritten pattern 20 into a command instruction. The execution unit 12 then executes a corresponding program, such as deleting a micro-pattern or adding a micro-pattern, etc, based on the command instruction

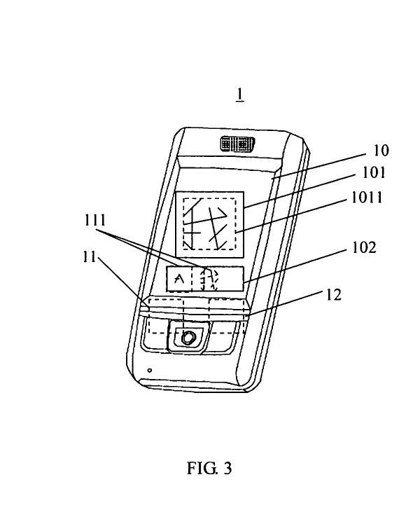

FIG. 3 is a further schematic view of the operation of a transmission apparatus of the present invention. A plurality of handwritten scripts 1011 are continuously inputted onto the handwritten screen 101 of the transmission apparatus 1 to generate a plurality of micro-patterns 111 displayed and arranged sequentially at a bottom position 102 of the handwritten screen 101 based on the input sequence of the plurality of handwritten scripts 1011.

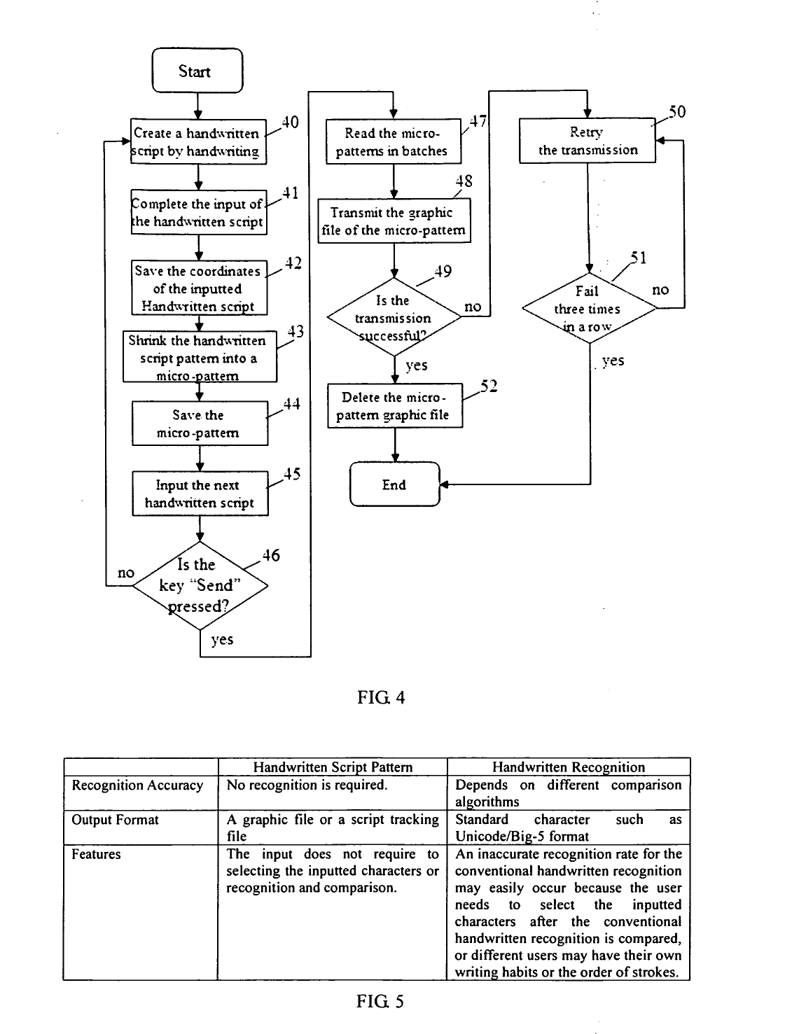

Referring to FIG. 4 for a transmission method according to a preferred embodiment of the present invention, the transmission of the invention comprises the following steps:

Step 40: A user uses a handwritten way to create a handwritten script onto a handwritten screen.

Step 41: If there is no action on the handwritten screen within a specific time such as 0.5 second, then it is determined that the user has completed inputting handwritten scripts.

Step 42: The input coordinates of the handwritten scripts are saved.

Step 43: Patterns and the handwritten scripts are shrunk to a micro-pattern with 64×64 pixels.

Step 44: The micro-pattern is temporarily saved into a data folder.

Step 45: The user then inputs another handwritten script.

Step 46: This step determines whether or not a command instruction given by the user is received. If not, then return to Step 40; if yes, go to Step 47.

Step 47: After all micro patterns transmitted by the user are received, all graphic files of the micro-patterns temporarily stored in the foregoing data folder are read in batches.

Step 48: A predetermined network protocol such as the Transmission Control Protocol/Internet Protocol (TCP/IP) is used to transmit the graphic file of the micro-patterns to an external receiving end designated by the user.

Step 49: This step confirms whether or not the transmission is successful; if not, then go to Step 50; and if yes, then go to Step 52.

Step 50: The network transmission is tried again; if the transmission fails, then go to Step 51.

Step 51: This step confirms whether or not the network transmission has failed for three times in a row; if yes, then end this transmission method (which indicates a failure of the user's network transmission); and if not, return to Step 50.

Step 52: After the graphic files of the related micro-patterns in the data folder is transmitted successfully as described in Step 49, then the graphic files in the data folder are deleted.

FIG. 5 is a comparison table between a handwritten script pattern in a transmission apparatus and transmission method thereof according to the present invention and a handwritten recognition of prior art. As shown, the handwritten script pattern of the invention requires no recognition while the conventional handwritten recognition relies on different comparison algorithms to confirm the accuracy of the recognition level. Further, the output format of the handwritten script of the present invention is a graphic file or a script tracking file while the output format of the conventional handwritten recognition is a standard character, such as Unicode/Big-5 format, created after comparing and recognizing through a computer. The input of the handwritten scripts according to the invention does not require users to select the inputted characters or carry out the recognition and comparison, and thus the present invention provides faster input and computation than the conventional handwritten recognition. To compare with the invention, an inaccurate recognition rate for the conventional handwritten recognition may easily occur because the user needs to select the inputted characters after the conventional handwritten recognition is compared, or different users may have their own writing habits or the order of strokes.

While the invention has been described by way of example and in terms of a preferred embodiment, it is to be understood that the invention is not limited thereto. It will be apparent to those skilled in this field that various modifications may be made in these embodiments without departing from the spirit and scope of the present invention.

What is claimed is:

1. A transmission apparatus, comprising:
a handwritten input unit, provided with a handwritten screen for inputting a handwritten script or a handwritten pattern;
a processing unit, for converting said handwritten script into a script pattern, and shrinking said script pattern to a micro-pattern, or for converting said handwritten pattern into a command instruction; and
an execution unit, for transmitting said micro-pattern to an external receiving end or for executing a corresponding program according to said command instruction.

2. The transmission apparatus of claim 1, wherein said transmission apparatus is a handheld apparatus.

3. The transmission apparatus of claim 1, wherein said handwritten screen is a touch screen.

4. The transmission apparatus of claim 1, wherein said handwritten script or said handwritten pattern is inputted by a finger.

5. The transmission apparatus of claim 1, wherein said script pattern and said micro-pattern are graphic files.

6. A transmission apparatus, comprising:
a handwritten input unit, provided with a handwritten screen for continuously inputting a plurality of handwritten scripts or at least one handwritten pattern;
a processing unit, for converting said handwritten scripts into a string of pluralized script patterns sequentially and then shrinking said script patterns to a string of pluralized micro-patterns sequentially, or for converting said handwritten pattern into a command instruction; and
an execution unit, for transmitting said micro-pattern to an external receiving end sequentially or for executing a corresponding program according to said command instruction.

7. The transmission apparatus of claim 6, wherein said transmission apparatus is a handheld apparatus.

8. The transmission apparatus of claim 6, wherein said handwritten screen is a touch screen.

9. The transmission apparatus of claim 6, wherein said handwritten script or said handwritten pattern are inputted by a finger.

10. The transmission apparatus of claim 6, wherein said script pattern and said micro-pattern are a plurality of graphic files.

11. A transmission method, comprising:
providing a handwritten screen, for inputting a handwritten script or a handwritten pattern;
converting said handwritten script into a script pattern and then shrinking said script pattern to a micro-pattern, or converting said handwritten pattern into a command instruction; and
transmitting said micro-pattern to an external receiving end, or executing a corresponding program according to said command instruction.

12. The transmission method of claim 11, wherein said transmission method is carried out by a handheld apparatus.

13. The transmission method of claim 11, wherein said handwritten screen is a touch screen.

14. The transmission method of claim 11, wherein said handwritten script or said handwritten pattern is inputted by a finger.

15. The transmission method of claim 11, wherein said script pattern and said micro-pattern are graphic files.

16. A transmission method, comprising:
providing a handwritten screen, for continuously inputting a plurality of handwritten scripts or at least one handwritten pattern;
converting said handwritten scripts into a string of pluralized script patterns sequentially and shrinking said script patterns to a string of pluralized micro-patterns sequentially, or converting said handwritten pattern into a command instruction; and
transmitting said micro-patterns to an external receiving end sequentially, or executing a corresponding program according to said command instruction.

17. The transmission apparatus of claim 16, wherein said transmission method is carried out by a handheld apparatus.

18. The transmission apparatus of claim 16, wherein said handwritten screen is a touch screen.

19. The transmission apparatus of claim 16, wherein said handwritten script or said handwritten pattern is inputted by a finger.

20. The transmission apparatus of claim 16, wherein said script pattern and said micro-pattern are a plurality of graphic files.
